(19) United States
(12) Patent Application Publication
(10) Pub. No.: US 2010/0031187 A1
(43) Pub. Date: Feb. 4, 2010

(54) Input Method and Touch-Sensitive Display Apparatus

(76) Inventor: Cheng-Hao Lee, Hsinchu City (TW)

Correspondence Address: HDLS Patent & Trademark Services, P.O. BOX 220746, CHANTILLY, VA, 20153-0746, US

(21) Appl. No.: 12/236,334

(22) Filed: Sep. 23, 2008

(30) Foreign Application Priority Data
Aug. 1, 2008 (TW) 097129458

(51) Int. Cl. G06F 3/048

(52) U.S. Cl. 715/798

(57) ABSTRACT

An input method is applied to a touch-sensitive display apparatus. The touch-sensitive display apparatus has a display area and the display area displays a first frame. The input method include a step of a pointer pressing the display area and moving to change the first frame. The step of the pointer pressing the display area and moving to change the first frame is accomplished through the following way. The way is that the pointer presses the display area and moves from a place where is adjacent to a corner of the display area to a place where is adjacent to a center of the display area along a first direction such that a folded image adjacent to the corner is displayed by the display area. In addition, a touch-sensitive display apparatus using the input method is provided.

### BACKGROUND

1. Field of the Invention

The present invention relates to an input method and a display apparatus, and more particularly, to an input method applied to a touch-sensitive display apparatus and a touch-sensitive display apparatus using the input method.

2. Description of the Related Art

FIG. 1 is a schematic view of a conventional display apparatus. The conventional display apparatus 100 has a display area 110 and a plurality of keys 120. When a user wants to shift a frame F11 displayed by the display area 110 to another frame, the user must press one of the keys 120 to perform the above operation.

However, some other operation instructions must be inputted by pressing some of the keys in order. Thus the conventional method of inputting the operation instructions by means of pressing the keys 120 is relatively complex.

### BRIEF SUMMARY

The present invention is directed to provide an input method applied to a touch-sensitive display apparatus such that the operation instructions are inputted simply into the touch-sensitive display apparatus.

The present invention is directed to provide a touch-sensitive display apparatus into which the operation instructions are inputted simply.

An input method applied to a touch-sensitive display apparatus in accordance with an embodiment of the present invention is provided. The touch-sensitive display apparatus has a display area and the display area displays a first frame. The input method comprises a step of a pointer pressing the display area and moving to change the first frame. The step of the pointer pressing the display area and moving to change the first frame is accomplished through the following way. The way is that the pointer presses the display area and moves from a place where is adjacent to a corner of the display area to a place where is adjacent to a center of the display area along a first direction such that a folded image adjacent to the corner is displayed by the display area.

In an embodiment of the present invention, the step of the pointer pressing the display area and moving to change the first frame is accomplished further through the following ways. One way is that the pointer presses the display area and moves along a second direction such that the first frame is zoomed in to become a second frame. The other way is that the pointer presses the display area and moves along a third direction such that the first frame is zoomed out to become a third frame. The second direction is opposite to the third direction and the second direction is parallel to a first boundary of the display area.

In an embodiment of the present invention, the step of the pointer pressing the display area and moving to change the first frame is accomplished further through the following ways. One way is that the pointer presses the display area and moves along a fourth direction such that the display area displays a fourth frame posterior to the first frame. The other way is that the pointer presses the display area and moves along a fifth direction such that the display area displays a fifth frame prior to the first frame. The fourth direction is opposite to the fifth direction and the fourth direction is parallel to a second boundary of the display area. The second boundary is substantially perpendicular to the first boundary.

A touch-sensitive display apparatus in accordance with an embodiment of the present invention is provided. The touch-sensitive display apparatus comprises a display panel and a touch-sensitive device. The display panel has a display area. The touch-sensitive device is disposed on the display panel. When the display area displays a first frame and a pointer presses the display area and moves from a place where is adjacent to a corner of the display area to a place where is adjacent to a center of the display area along a first direction, a folded image adjacent to the corner is displayed by the display area.

In an embodiment of the present invention, when the display area displays the first frame and the pointer presses the display area and moves along a second direction, the first frame is zoomed in to become a second frame. When the display area displays the first frame and the pointer presses the display area and moves along a third direction, the first frame is zoomed out to become a third frame. The second direction is opposite to the third direction and the second direction is parallel to a first boundary of the display area.

In an embodiment of the present invention, when the display area displays the first frame and the pointer presses the display area and moves along a fourth direction, the display area displays a fourth frame posterior to the first frame. When the display area displays the first frame and the pointer presses the display area and moves along a fifth direction, the display area displays a fifth frame prior to the first frame. The fourth direction is opposite to the fifth direction and the fourth direction is parallel to a second boundary of the display area. The second boundary is substantially perpendicular to the first boundary.

In an embodiment of the present invention, the display panel further comprises a first surface and a second surface. The display area is located at the first surface and the first surface is opposite to the second surface. The touch-sensitive device comprises a plurality of pressure sensors and a base. The pressure sensors are disposed on the second surface and corresponding to the display area. The base is disposed on the pressure sensors such that the pressure sensors are located between the second surface and the base.

Since the pointer presses the display area and moves to change the first frame, the operation instructions are inputted simply into the touch-sensitive display apparatus using the input method of the embodiment of the present invention.

### BRIEF DESCRIPTION OF THE DRAWINGS

The accompanying drawings are included to provide a further understanding of the invention, and are incorporated in and constitute part of this specification. The drawings illustrate embodiments of the invention and, together with the description, serve to explain the principles of the invention.

FIG. 1 is a schematic view of a conventional display apparatus.

FIG. 2 is a schematic view of a touch-sensitive display apparatus of an embodiment of the present invention.

FIG. 3 is a flow chart of an input method applied to the touch-sensitive display apparatus of FIG. 2.

FIG. 4A is a schematic view of the display area of FIG. 2 displaying a first frame at a first time.

FIG. 4B is a schematic view of the display area of FIG. 2 displaying a folded image at a second time.

FIG. 5 is a schematic view of the display area of FIG. 2 displaying a second frame at another second time.

FIG. 6 is a schematic view of the display area of FIG. 2 displaying a third frame at another second time.

FIG. 7 is a schematic view of the display area of FIG. 2 displaying a fourth frame at another second time.

FIG. 8 is a schematic view of the display area of FIG. 2 displaying a fifth frame at another second time.

FIG. 9 is a schematic cross-sectional view of the touch-sensitive display apparatus of FIG. 2 along a line A-A.

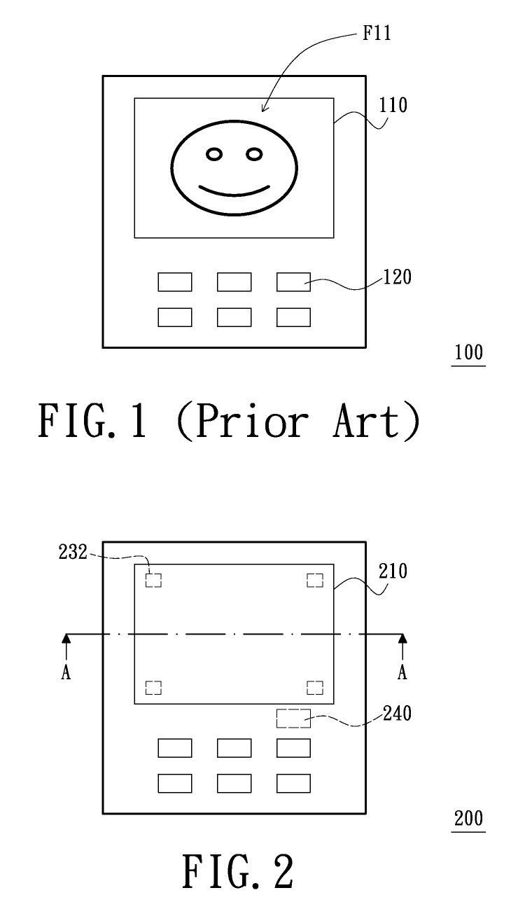

### DETAILED DESCRIPTION

Reference will now be made to the drawings to describe exemplary embodiments of the present input method, in detail. The following description is given by way of example, and not limitation.

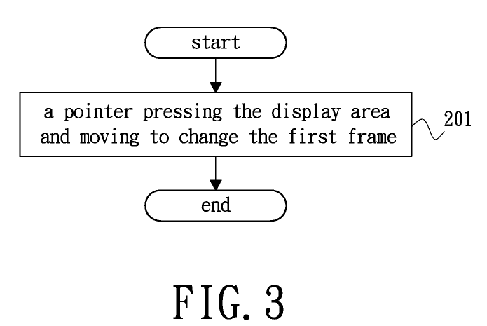

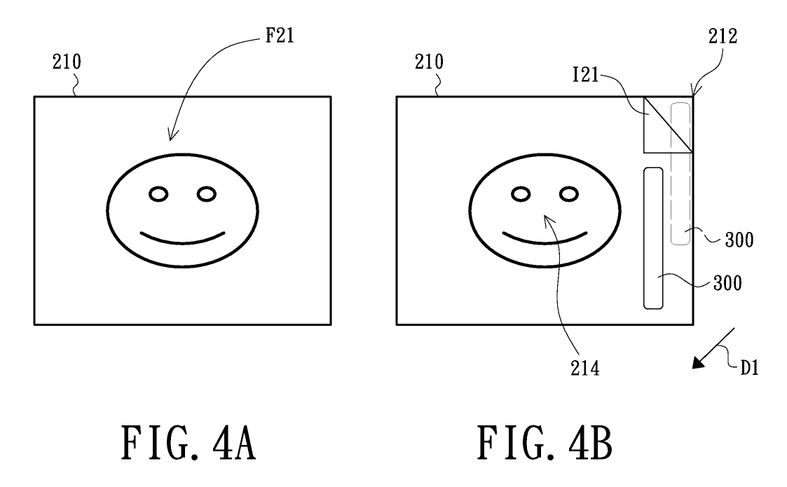

FIG. 2 is a schematic view of a touch-sensitive display apparatus in accordance with an embodiment of the present invention. FIG. 3 is a flow chart of an input method applied to the touch-sensitive display apparatus of FIG. 2. FIG. 4A is a schematic view of the display area of FIG. 2 displaying a first frame at a first time. FIG. 4B is a schematic view of the display area of FIG. 2 displaying a folded image at a second time.

Referring to FIGS. 2, 3, 4A and 4B, the input method of the present embodiment is applied to a touch-sensitive display apparatus 200. The touch-sensitive display apparatus 200 has a display area 210 and the display area 210 displays a first frame F21 at a first time. The input method includes the step 201. The step 201 is that a pointer 300 presses the display area 210 and moves to change the first frame F21. The step of the pointer 300 pressing the display area 210 and moving to change the first frame F21 is accomplished through the following way. The way is that the pointer 300 presses the display area 210 and moves from a place where is adjacent to a corner 212 of the display area 210 to a place where is adjacent to a center 214 of the display area 210 along a first direction D1 such that a folded image 121 adjacent to the corner 212 is displayed by the display area 210 at a second time. The second time is later than the first time. In the present embodiment, the pointer 300 is a forefinger of a user or a touch pen.

It should be noted that the corner 212 of the present embodiment is the upper right corner of the display area 210 as shown in FIG. 4B. Alternatively, the corner 212 may be the lower right corner, the upper left corner or the lower left corner of the display area 210. The scope of the present invention is not limited herein.

To be brief, the user may employ the pointer 300 to press the display area 210 and move the pointer 300 a specific distance along the first direction D1, so the first frame F21 (displayed at the first time) is marked with the folded image 121 (displayed at the second time).

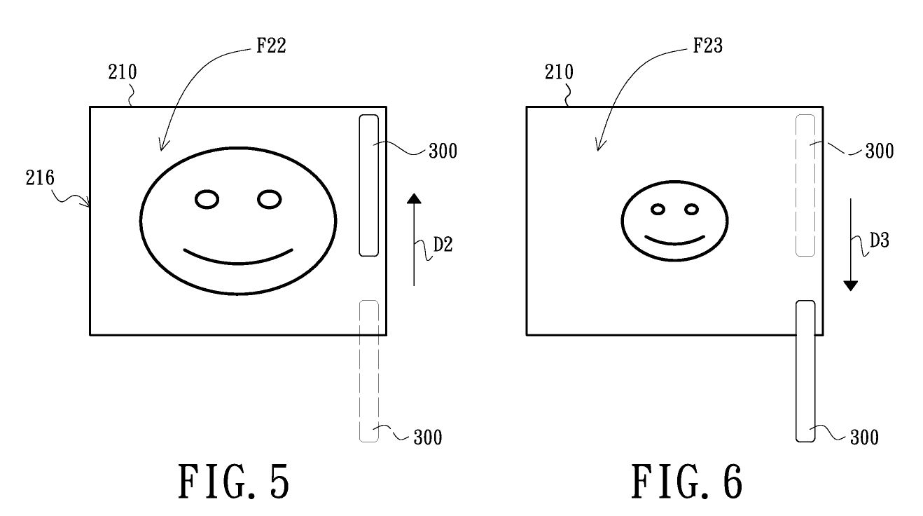

FIG. 5 is a schematic view of the display area of FIG. 2 displaying a second frame at another second time. FIG. 6 is a schematic view of the display area of FIG. 2 displaying a third frame at another second time. In the present embodiment, the step of the pointer 300 pressing the display area 210 and moving so as to change the first frame F21 is accomplished further through the following ways. Referring to FIGS. 2, 3, 4A and 5, one way is that the pointer 300 presses the display area 210 and moves along a second direction D2 such that the first frame F21 displayed by the display area 210 at the first time is zoomed in to become a second frame F22 displayed by the display area 210 at the second time. Referring to FIGS. 2, 3, 4A and 6, the other way is that the pointer 300 presses the display area 210 and moves along a third direction D3 such that the first frame F21 displayed by the display area 210 at the first time is zoomed out to become a third frame F23 displayed by the display area 210 at the second time. The second direction D2 is opposite to the third direction D3 and the second direction D2 is parallel to a first boundary 216 of the display area 210. The second direction D2 of the present embodiment is from bottom to top, and the third direction D3 thereof is from top to bottom.

To be brief, the user may employ the pointer 300 to press the display area 210 and move the pointer 300 a specific distance along the second direction D2 or the third direction D3, so the first frame F21 (displayed at the first time) is zoomed in to become the second frame F22 (displayed at the second time) or zoomed out to become the third frame F23 (displayed at the second time).

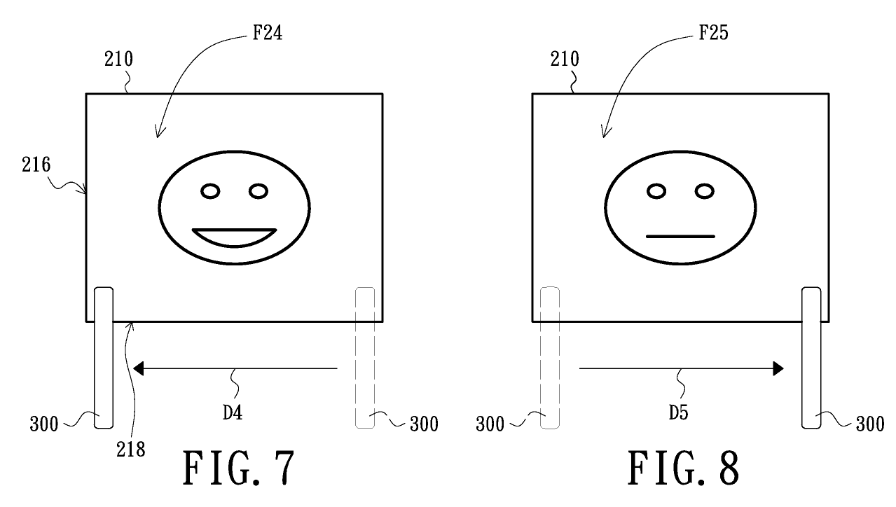

FIG. 7 is a schematic view of the display area of FIG. 2 displaying a fourth frame at another second time. FIG. 8 is a schematic view of the display area of FIG. 2 displaying a fifth frame at another second time. In the present embodiment, the step of the pointer 300 pressing the display area 210 and moving to change the first frame F21 is accomplished further through the following ways. Referring to FIGS. 2, 3, 4A and 7, one way is that the pointer 300 presses the display area 210 and moves along a fourth direction D4 such that the first frame F21 displayed by the display area 210 at the first time is changed to become a fourth frame F24 displayed by the display area 210 at the second time. Referring to FIGS. 2, 3, 4A and 8, the other way is that the pointer 300 presses the display area 210 and moves along a fifth direction D5 such that the first frame F21 displayed by the display area 210 at the first time is changed to become a fifth frame F25 displayed by the display area 210 at the second time.

It should be noted that the order of the fifth frame F25, the first frame F21 and the fourth frame F24 is predetermined. For example, the fifth frame F25, the first frame F21 and the fourth frame F24 may be a segment of electrical data of a book. The fifth frame F25, the first frame F21 and the fourth frame F24 may be pages 18, 19 and 20 of the book, respectively. In addition, the fourth direction D4 is opposite to the fifth direction D5 and the fourth direction D4 is parallel to a second boundary 218 of the display area 210. The second boundary 218 is substantially perpendicular to the first boundary 216. The fourth direction D4 of the present embodiment is from right to left and the fifth direction D5 is from left to right.

To be brief, the user may employ the pointer 300 to press the display area 210 and move the pointer 300 a specific distance along the fourth direction D4 or the fifth direction D5, so the first frame F21 (displayed at the first time) is changed to become the fourth frame F24 (displayed at the second time) posterior to the first frame F21 or to become the fifth frame F25 (displayed at the second time) prior to the first frame F21.

It should be noted that referring to FIGS. 5 to 8, in another embodiment, the second direction D2 and the third direction D3 are parallel to the second boundary 218 of the display area 210 and the fourth direction D4 and the fifth direction D5 are parallel to the first boundary 216 of the display area 210. However, the above mentioned is not shown in any drawing.

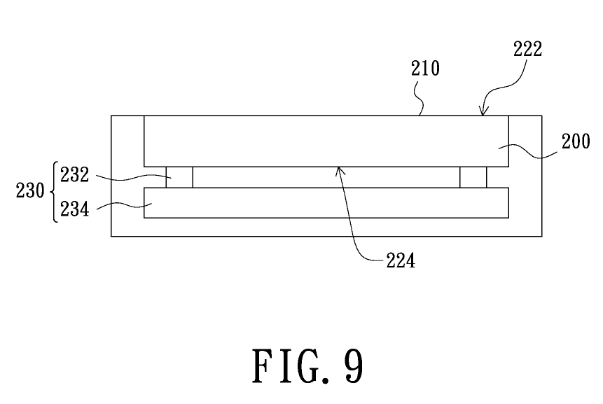

FIG. 9 is a schematic cross-sectional view of the touch-sensitive display apparatus of FIG. 2 along a line A-A. Referring to FIGS. 2 and 9, the touch-sensitive display apparatus 200 of the present embodiment includes a display panel 220 and a touch-sensitive device 230. The display panel 220 may be an electrophoretic display panel or a liquid crystal display panel and has the display area 210. The display panel 220 further includes a first surface 222 and a second surface 224. The display area 210 is located at the first surface 222 and the first surface 222 is opposite to the second surface 224.

The touch-sensitive device 230 is disposed on the display panel 220. The touch-sensitive device 230 includes a plurality of pressure sensors 232 and a base 234. The pressure sensors 232 are disposed on the second surface 224 of the display panel 220 and corresponding to the display area 210. The base 234 is disposed on the pressure sensors 232 such that the pressure sensors 232 are located between the second surface 224 and the base 234. When the pointer 300 (as shown in FIG. 4B) presses the display area 210, the pressure sensors 234 sense the pressure change in the display area 210 and convert the pressure change into electrical signals which are processed afterwards by a processor 240 of the touch-sensitive display apparatus 210 such that the above input method is performed.

In summary, the input method and the touch-sensitive display apparatus of the embodiment of the present invention at least has one of the following advantages or other advantages.

1. Since the pointer presses the display area and moves to change the first frame, the operation instructions are inputted simply into the touch-sensitive display apparatus using the input method of the embodiment of the present invention.

2. Since the pressure sensors are disposed on the second surface of the display panel and the second surface is opposite to the first surface at which the display area is located, the frames displayed by the display area are not affected by the touch-sensitive device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An input method applied to a touch-sensitive display apparatus having a display area displaying a first frame, the method comprising:
a pointer pressing the display area and moving to change the first frame, wherein the step of the pointer pressing the display area and moving to change the first frame comprises:
the pointer pressing the display area and moving from a place where is adjacent to a corner of the display area to a place where is adjacent to a center of the display area along a first direction such that a folded image adjacent to the corner is displayed by the display area.

2. The input method as claimed in claim 1, wherein the step of the pointer pressing the display area and moving to change the first frame further comprises:
the pointer pressing the display area and moving along a second direction such that the first frame is zoomed in to become a second frame; and
the pointer pressing the display area and moving along a third direction such that the first frame is zoomed out to become a third frame, the second direction being opposite to the third direction and the second direction being parallel to a first boundary of the display area.

3. The input method as claimed in claim 2, wherein the step of the pointer pressing the display area and moving to change the first frame further comprises:
the pointer pressing the display area and moves along a fourth direction such that the display area displays a fourth frame posterior to the first frame; and
the pointer pressing the display area and moves along a fifth direction such that the display area displays a fifth frame prior to the first frame, the fourth direction being opposite to the fifth direction, the fourth direction being parallel to a second boundary of the display area and the second boundary being substantially perpendicular to the first boundary.

4. A touch-sensitive display apparatus, comprising:
a display panel having a display area; and
a touch-sensitive device disposed on the display panel, wherein when the display area displays a first frame and a pointer presses the display area and moves from a place where is adjacent to a corner of the display area to a place where is adjacent to a center of the display area along a first direction, a folded image adjacent to the corner is displayed by the display area.

5. The touch-sensitive display apparatus as claimed in claim 4, wherein when the display area displays the first frame and the pointer presses the display area and moves along a second direction, the first frame is zoomed in to become a second frame; when the display area displays the first frame and the pointer presses the display area and moves along a third direction, the first frame is zoomed out to become a third frame; the second direction is opposite to the third direction and the second direction is parallel to a first boundary of the display area.

6. The touch-sensitive display apparatus as claimed in claim 5, wherein when the display area displays the first frame and the pointer presses the display area and moves along a fourth direction, the display area displays a fourth frame posterior to the first frame; when the display area displays the first frame and the pointer presses the display area and moves along a fifth direction, the display area displays a fifth frame prior to the first frame; the fourth direction is opposite to the fifth direction, the fourth direction is parallel to a second boundary of the display area and the second boundary is substantially perpendicular to the first boundary.

7. The touch-sensitive display apparatus as claimed in claim 4, wherein the display panel further comprises a first surface and a second surface, the display area is located at the first surface, the first surface is opposite to the second surface, the touch-sensitive device comprises a plurality of pressure sensors and a base, the pressure sensors are disposed on the second surface and corresponding to the display area, and the base is disposed on the pressure sensors such that the pressure sensors are located between the second surface and the base.
